(19) United States
(12) Patent Application Publication
(10) Pub. No.: US 2026/0242153 A1
(43) Pub. Date: Aug. 20, 2026

(54) CONVEYOR PLANT WITH WEAR DETECTION SYSTEM AND RELATED ELECTROMAGNETIC METHOD

(71) Applicant: CICSA S.R.L., Brivio (LC) (IT)

(72) Inventors: Stefano CAMPANARI, Brivio (LC) (IT); Marco CAMPANARI, Brivio (LC) (IT)

(73) Assignee: CICSA S.R.L., Brivio (LC) (IT)

(21) Appl. No.: 19/161,922

(22) PCT Filed: Mar. 18, 2024
(86) PCT No.: PCT/IB2024/052608

§ 371 Date: Sep. 3, 2025

(30) Foreign Application Priority Data
Mar. 17, 2023 (IT) 102023000005130

(51) Int. Cl. B65G 43/02; G01B 7/15

(52) U.S. Cl. CPC B65G 43/02; G01B 7/15

(57) ABSTRACT

Conveyor equipment having a detection system connected to a transmission assembly is provided. The detection system includes first and second magnetic elements arranged on the conveyor movement element, an electrical winding arranged on a ferromagnetic core, but not integral in motion with respect to the movement element, an electric sensor for the electrical winding to detect an electrical property of the electric current induced by the relative motion between the electrical winding and the first and second magnetic elements, a control unit, configured to estimate the difference between the actual value of the distance between the first and second magnetic elements and a reference value of the distance between the first and second magnetic elements to detect a state of wear and/or defectiveness of the transmission assembly.

### FIELD OF INVENTION

The present invention relates to a conveyor equipment with a wear and/or defectiveness state detection system and the related method of detecting the state of wear and/or defectiveness of the aforesaid conveyor equipment.

Specifically, the present invention relates to a conveyor equipment for conveying materials, having a system for detecting the state of wear and/or defectiveness of its components, more specifically to a conveyor equipment using belts or chains as driving element. As mentioned above, the present invention also relates to the respective method of detecting the state of wear and/or defectiveness of the components of the conveyor equipment using belts or chains.

### KNOWN PRIOR ART

In the industrial field, the use of material conveyor equipment is particularly common, specifically for materials either in bulk or in individual pieces or parts. The industry sector and the intended use of the conveyor equipment itself will influence the choice of the most suitable conveyor equipment for the circumstances. The most well-known and popular categories of conveyor equipment are: belt conveyors, roller conveyors, screw conveyors and chain conveyors.

Conveyors can be horizontal, inclined or vertical, with straight paths or with one or more changes of direction; in the case of vertical conveyors, they are called elevators.

In their most general form, chain or belt conveyor equipment consist of at least one movement element of the chain or belt type, which can be moved along a path that follows either an open line (for example, in the case of reciprocating transport in translating and lifting systems) or, more often, a closed line, that is to say forming a closed figure (in the case of continuous conveyor equipment), which is typically actuated by one or more shafts, at least one of which being a drive shaft. Such shafts are usually equipped with crown or cogwheels to transmit motion to the movement element.

In particular, chain conveyors provide a longer service life than other categories of conveyor equipment and have high abrasion resistance and high temperature resistance. These characteristics make them particularly suitable for use in industrial sites where the atmosphere is particularly aggressive or/and powdery. Typically, the chain is made up of a plurality of links, which may be composed of individual rings (ring chains) or of several elements (for example plates, pins and possibly bushings in articulated chains, also known as mechanical type chains, or of molded “fork-like” links also known as molded or drag chains), interconnected to each other so as to ensure mutual motion between links with at least one degree of freedom and, thus, allow the chain to form a line that may be either open, straight in one or more directions or curved, or a closed curve, sometimes called a catenary or “chain turn”.

The movement element may be combined with one or more conveying elements, such as buckets or scraper elements or supporting and holding elements for supporting and holding a load, which are driven to move by the movement element itself and are configured to transport material, typically but not necessarily bulk material, along at least part of the extent of the movement element.

Due to critical working conditions under which they often operate, conveyor equipment are frequently subjected to heavy operations in terms of mechanical stresses. In addition, the integrity of components of the conveyor equipment can be jeopardized by the presence of abrasive materials, process debris and sometimes foreign bodies, which often get inside the moving components.

Thus, conveyor equipment are subject to wear which, if neglected, will result in malfunction or failure. solving such problems requires a temporary shutdown of the conveyor equipment to allow inspection operations and repair or replacement of worn or damaged components. Therefore, solving anomalies and failures often implies quite long downtimes, which affect the performance of the entire production plant often with significant consequences, also from an economic point of view.

In order to avoid downtimes of the conveyor equipment due to failure of its mechanical components, periodic inspections are currently provided in order to take measurements, such as detecting dimensional changes of components, for example thicknesses and other critical dimensions, to identify possible local deformations and/or worn components which, if kept further in operation, could cause malfunctions and, as a result, long downtimes.

These periodic inspections are typically carried out at intervals of the order of a few months by trained personnel, possibly with the aid of appropriate tooling kit, and require the conveyor equipment to be in a shutdown state, appropriate inspection doors to be opened and/or protective and cover parts of the equipment to be disassembled, and, in most cases, transported material to have been removed from the equipment. Even if the conveyor equipment is shut down, inspection operations expose workers to safety hazards as they work in the proximity of the conveyor equipment, in contact with significant amounts of the material being transported, with potential dustiness and/or toxicity issues, and also often operating at considerable heights above the ground. In addition, operations to measure dimensional changes in components are not straightforward, are influenced by the operator's experience and are potentially subject to errors in both detection and interpretation. Therefore, in the industrial sector, and especially in the industry that uses conveyor equipment, there is a particular need to be able to continuously map and control the state of wear of the aforesaid components in order to optimally schedule their maintenance or periodic replacement, as well as to prevent problems of excessive stress due to abnormal operating conditions that can lead to the risk of breakage of the equipment components, thus maximizing the useful life of the components and the operation of the conveyor equipment.

### BRIEF DESCRIPTION OF THE INVENTION

Therefore, object of the present invention is to overcome the aforementioned drawbacks of the known art. Therefore, object of the present invention is then to provide a conveyor equipment that is able to continuously detect the state of wear and/or defectiveness of the components of the conveyor equipment itself, so as to be able to collect operating data thereof, map its progress in real time, estimate and predict its evolution, schedule periodic maintenance or replacement and prevent excessive stresses that could lead to failure or breakage to be established.

Another object of the present invention is to provide a system for detecting the state of wear and/or defectiveness of a conveyor equipment of the type operating along a path that follows an open or closed line, such as a conveyor belt or chain conveyor or the like.

A further object of the present invention is to provide a method of real time detection of the state of wear and/or defectiveness of a conveyor equipment, which allows the conditions of the conveyor equipment itself to be continuously monitored, which allows its evolution to be predicted, and which signals any anomalies or the need to provide preventive maintenance or replacement operations of one or more components of the conveyor equipment.

These and other objects are achieved by means of a conveyor equipment according to claim 1, according to a detection system for detecting the wear and/or defectiveness of a movement element of a transmission assembly of a conveyor equipment according to claim 7, and a method for detecting the state of wear and/or defectiveness of a conveyor equipment according to claim 10. Preferred aspects of the present invention are set forth in the dependent claims.

According to an aspect, a conveyor equipment comprises:-a transmission assembly comprising at least one movement element movable along a path, which may follow either an open line, as discussed above generally in the case of reciprocating transport as in translating and lifting systems, or (more preferably) a closed line, preferably in the form of a chain or belt, said transmission assembly further comprising at least one drive shaft operatively connected to said movement element for motion transfer; a wear and/or defectiveness detection system operatively connected to said transmission assembly and configured to detect the state of wear and/or defectiveness of said transmission assembly. The detection system comprises:
at least one first magnetic element and one second magnetic element arranged at a distance from each other on said movement element, at least one electrical winding placed on a respective ferromagnetic core arranged to be fixed, or anyway not integral (in motion), with respect to said movement element,
at least one electric sensor for each electrical winding, configured to detect one or more electrical properties, preferably at least the voltage, of the electric current induced by the relative motion between said at least one electrical winding and said first and second magnetic elements,
at least one control unit, configured to estimate, as a function of the data detected by said electric sensor, the difference between the actual value of the distance between said first magnetic element and said second magnetic element and a predefined reference value of the distance between said first magnetic element and said second magnetic element, so as to detect a state of wear and/or defectiveness of said transmission assembly.

It should be noted here that the expression “conveyor equipment” means any closed-loop conveyor equipment of the belt type or chain type, that is, of the type having links or plates connected in succession by means of end pins, or chained rings, which is able to transport any type of product along any direction.

The expression “control unit” means any generic controller of automatic or semi-automatic type, preferably programmable and able to capture the moment of passage and/or the speed and/or the mutual distance between the two magnetic elements in order to evaluate any state of wear or defectiveness in the equipment. Specifically, by means of the electric sensor, the control unit thus detects the passage of magnetic elements at an electrical winding. For example, by evaluating the time elapsed between the passage of magnetic elements at one or more electrical windings placed at a fixed, known distance, it is possible to estimate the difference between the actual distance between the magnetic elements and a predefined target distance. Furthermore, the speed of motion of the moving magnetic elements can be evaluated, and from this, for example, the actual distance between the magnetic elements can be derived and/or, at any rate, any anomalies in the operation of the moving element, compared to what was expected during the design step and/or the first installation step, can be identified. The target—i.e. reference—distance is typically that at which the magnetic elements were originally assembled. In case of wear or defectiveness of the transmission assembly, the movement element typically tends to become longer. In this case, the distance between the magnetic elements (which are integral with the movement element) increases. Therefore, if the actual distance between the magnetic elements is greater than the target distance, the control unit can detect a state of wear in the movement element. In the present description, the term “wear” refers to the deterioration or attrition that the components of the transmission assembly undergo during the life cycle of the conveyor equipment. The term “defectiveness”, on the other hand, refers to a fault or failure condition that causes a malfunction, or even shutdown, of the conveyor equipment. Therefore, it should be understood that defectiveness represents a more serious condition than wear, which, if neglected over time, can lead to defectiveness. Defectiveness can also be caused by other factors, such as overloading or excessive temperatures on the components of the transmission assembly.

According to an aspect of this invention, the conveyor equipment is of the chain type, i.e. the movement element comprises a plurality of links or rings or plates, or other movable units, which are constrained together with at least one degree of freedom.

For example, according to this aspect of the invention, the movement element of this chain conveyor equipment may comprise a plurality of links or plates connected to each other by pins arranged at their respective ends or a plurality of rings chained with each other.

In an embodiment, such a chain conveyor equipment can provide that at least one movable unit, which is part of the movement element, comprises both the aforesaid first magnetic element and the aforesaid second magnetic element.

Such a chain equipment can of course be a driving element for transporting materials in horizontal, oblique, vertical direction or a combination of the previous directions to create, preferably but not necessarily, an articulated path.

According to a further aspect, the aforesaid two magnetic elements are arranged so that they have opposite polarities facing the aforesaid at least one electrical winding.

According to another aspect of this invention, a system for detecting the wear and/or defectiveness of a movement element belonging to a transmission assembly of a conveyor equipment, which is movable along a path, is claimed herein and is configured to be operatively connected to the aforesaid transmission assembly, as to detect the wear and/or defectiveness state of the same transmission assembly, comprising:
at least one first magnetic element and one second magnetic element, each preferably comprising one or more permanent magnets shaped so as to be fixed, for example and preferably, at a distance from each other, on the said movement element,
at least one electrical winding placed on a respective ferromagnetic core, which is shaped to be arranged fixed, or anyway not integral, with respect to this movement element,
at least one electric sensor for each electrical winding, configured to detect one or more electrical properties, preferably but not exclusively, at least the voltage of the electric current induced by the relative motion between the at least one electrical winding and said first and second magnetic elements, and
at least one control unit, configured to estimate, as a function of the data detected by said electric sensor, the difference between the actual value of the distance between the first magnetic element and the second magnetic element and a predefined reference value of the distance between said first magnetic element and said second magnetic element, so as to detect a state of wear and/or defectiveness of the transmission assembly.

Advantageously, the conveyor equipment of the present invention, i.e. the wear and/or defectiveness detection system described hereinabove allow the detection of a state of wear and/or defectiveness of at least one of the components of the transmission assembly, without subjecting the entire system having said wear and/or defectiveness detection system operatively combined therewith, to temporary shutdowns to allow inspection operations by trained personnel. Still advantageously, the conveyor equipment of the present invention, and the aforementioned wear and/or defectiveness detection system when combined with a generic conveyor equipment, allow the state of wear of the transmission assembly to be continuously monitored in order to accurately schedule any preventive maintenance, thus preventing excessive component attrition from leading to major failures and breakage that result in long shutdowns of the entire conveyor equipment or, conversely, preventing overly early and prudent replacements of the components themselves. It should be noted that, as better discussed later, the control unit can either initially estimate the actual value of the distance between the magnetic elements, to compare it with the predefined value, or directly estimate the presence of a difference between the actual value and the predefined reference value of the distance, typically in the case several electrical windings placed at a distance from each other.

According to an aspect of the invention, the conveyor equipment can be of the continuous belt type or of the chain type, with links, plates, rings or other chained movable units.

According to another aspect, the conveyor equipment comprises at least one conveyor element connected to said movement element and configured to transport materials.

According to a possible aspect, at least one magnetic element, preferably each magnetic element, comprises permanent magnets, preferably two permanent magnets.

According to a possible aspect, the ferromagnetic core is the central bar of an “E-shaped” ferromagnetic element.

According to a possible aspect, the conveyor equipment, or at any rate said wear and/or defectiveness detection system, is configured so that the control unit evaluates the difference between actual value and predefined reference value of the distance between the magnetic elements as a function of the time difference elapsed between the passage of the magnetic elements at the same electrical winding. This difference is evaluated by analyzing the electrical signals detected by the aforementioned electric sensors, by methods and algorithms that can be implemented by a person skilled in the art.

According to a possible aspect, the conveyor equipment, as well as said wear and/or defectiveness detection system, is configured so that the control unit evaluates the difference between actual value and predefined reference value of the distance between the magnetic elements as a function of the time difference elapsed between the passage of the magnetic elements at different electrical windings placed at a known distance from each other.

An aspect of the present invention also relates to a method of detecting the wear and/or defectiveness state of a conveyor equipment according to any one of the preceding aspects, Comprising the following steps:
actuating said transmission assembly, so as to move said movement element and the magnetic elements integral therewith;
estimating, by said at least one sensor, the difference between the actual value of the distance between said first magnetic element and said second magnetic element and a predefined reference value of the distance between said first magnetic element and said second magnetic element, so as to detect a state of wear and/or defectiveness of said transmission assembly;
evaluating a state of wear and/or defectiveness of the transmission assembly as a function of the estimation of said distance.

The movement element is preferably in the form of a belt or chain, typically in the form of a chain. Thus, in the present document, the term “chain conveyor equipment” means any conveyor equipment using a chain of any kind as a driving element to transport materials along a horizontal, oblique, vertical direction or along any combination of the previous directions to create articulated paths. To this category of conveyor equipment belong, for example, bucket conveyors/elevators and drag-chain conveyors immersed in any environment (atmospheric, gaseous, submerged in water or other liquid, etc.) .

According to the embodiment, said at least one chain may be a ring chain or an articulated chain, that is, formed of plates, or similar components, interconnected to each other by pins and possibly bushings, or a chain with molded “fork-like” links interconnected to each other by pins.

However, the present invention can also be applied to any type of conveyor equipment having a transmission assembly with a movement element that travels along a path that follows an open or closed line, such as a loop, and not necessarily according to a single direction, of any type used in any kind of production plant, for example a wire mesh conveyor belt, or a synthetic conveyor belt, etc.

Specifically, the aforesaid wear and/or defectiveness detection system of the present invention can be applied to any conveyor equipment of the type having with a transmission assembly with a movement element movable along a path that follows an open or closed line.

For the sake of completeness, it should be noted that, as known, the transmission assembly also comprises at least one drive shaft which is operatively connected to the movement element for motion transfer. The drive shaft is typically rotated by at least one motor, typically an electric motor, and having contact and interaction members designed to contact and interact with the movement element in order to make the motion transfer more efficient. Preferably, the contact and interaction members comprise at least one smooth or toothed wheel to transfer the rotary motion of the drive shaft to the movement element. Still preferably, the transmission assembly comprises one or more free idler stations comprising, for example, a smooth or toothed idler wheel. The movement element is then fitted on said at least one drive shaft and, if present, on said one or more idler stations.

### BRIEF DESCRIPTION OF THE FIGURES

Further characteristics and advantages of the invention will become apparent from the following description provided by way of non-limiting example, with the aid of the figures depicted in the attached drawings, in which:

FIG. 1 illustrates an embodiment of the conveyor equipment according to the present invention, in a conveyor equipment having a movement element movable along a path that follows a closed line;

FIG. 2 illustrates a detail of the conveyor equipment in FIG. 1, and in particular illustrates a diagram of a part of the detection system of that equipment;

FIG. 3 is an operating diagram of part of the detection system in FIG. 2;

FIG. 4 illustrates another embodiment of the conveyor equipment according to the present invention;

FIG. 5 illustrates a further embodiment of the conveyor equipment according to the present invention.

### DETAILED DESCRIPTION OF AT LEAST ONE EMBODIMENT

With reference to the appended figures, the number 1 denotes a material conveyor equipment; in particular, a chain conveyor equipment 1, which is the preferred embodiment of the present invention, is shown in the figures, although the following description generally applies to conveyor elements with different movement elements, including belt movement elements. As mentioned above, in the present description the term “chain conveyor equipment” means any conveyor equipment using a chain as a driving element to transport materials along a horizontal, oblique, vertical direction or along a combination of the previous directions to create an articulated path. For example, bucket conveyors or drag chain conveyors belong to this category of conveyor equipment.

As known in the art, the chain referred to herein consists of a plurality of movable units mechanically connected to each other so that there can be relative motion of one movable unit with respect to those constrained thereto, preferably with at least one degree of freedom. These movable units may preferably consist of links or plates connected to each other by pins arranged at respective ends, or of rings chained with each other, or other elements known in the art.

The attached figures show, by way of example and in no way limiting, a conveyor equipment with a movement element that follows a closed line (closed loop), of the type called a “bucket elevator,” intended to transport materials in a vertical direction inside containers, commonly referred to as buckets. As discussed, even though the closed path is the preferred embodiment, embodiments in which the movement element follows an open path, typically via reciprocating motion, are not excluded. As shown in the figures, the conveyor equipment 1 comprises a transmission assembly 2. The transmission assembly 2 comprises at least one movement element 20 movable along a path that follows a closed line. As discussed, in the illustrated embodiment the transmission assembly 2 comprises a single chain-shaped movement element 20, however different numbers and/or types of movement elements are possible. For example, multiple movement elements 20 arranged in parallel with each other can be used.

In the case illustrated here, the chain is composed of a plurality of links 201 (movable units) interconnected to each other to form a closed curve, also called “chain turn” or catenary.

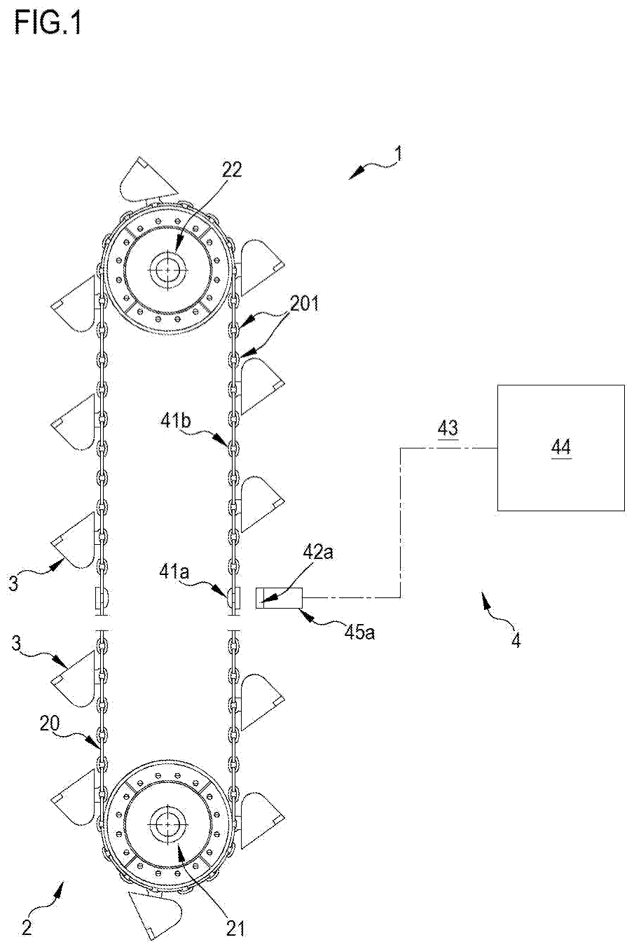

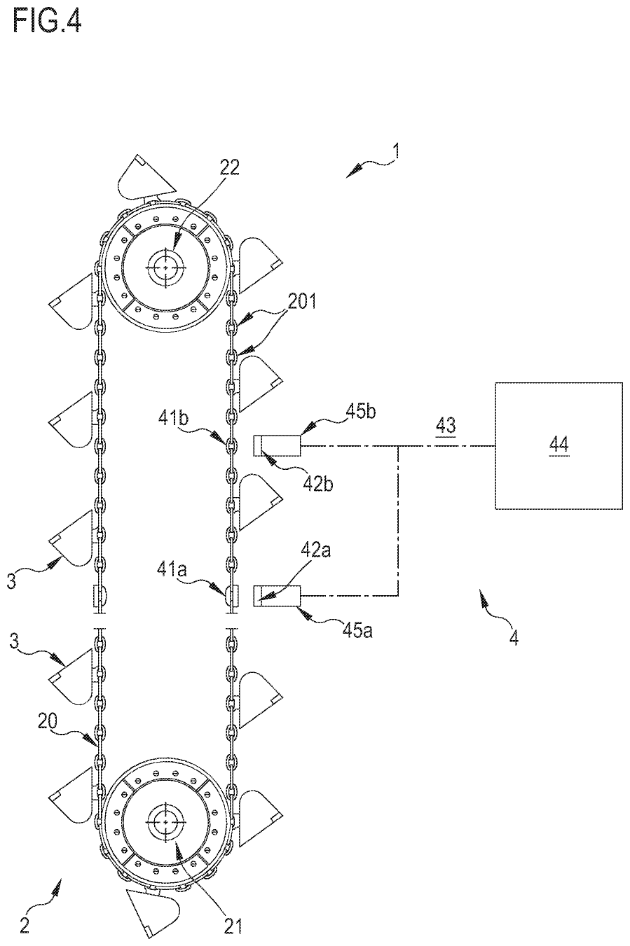

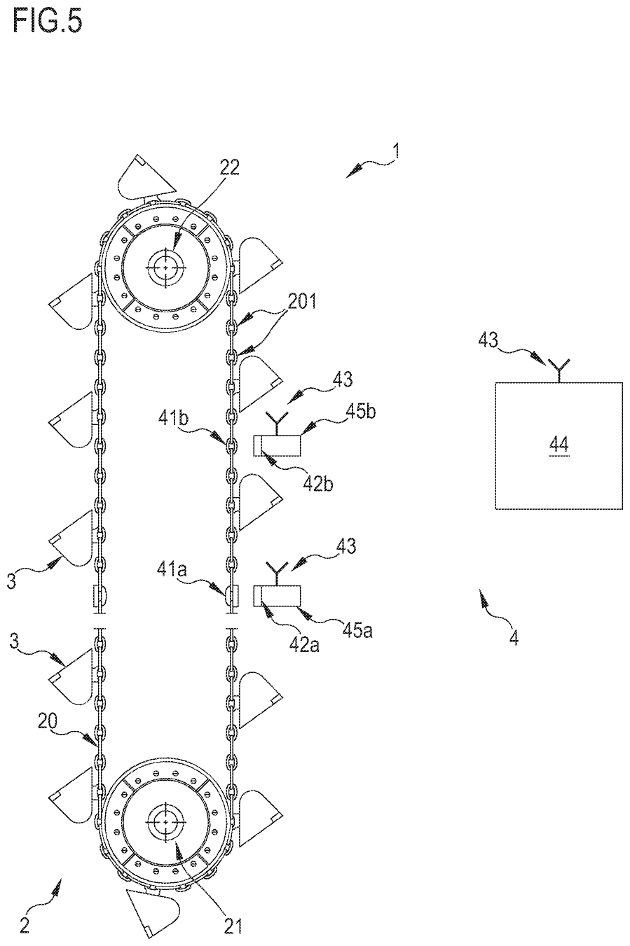

Specifically, as illustrated in the attached figures, the plurality of links 201 is composed of a plurality of rings that are connected together, that is, chained. According to not illustrated embodiments, the chain 20 may be a chain of another type, such as articulated, and, thus, the plurality of links 201 is composed of a plurality of “fork-like” molded links interconnected by appropriate pins or plates, or similar mechanical elements, connected to each other by means of pins or pin-bush connections to ensure a relative motion between the links or plates themselves, preferably with a degree of freedom. In addition, the transmission assembly 2 comprises at least one drive shaft. In the embodiment shown in FIGS. 1, 4 and 5, the transmission assembly comprises a drive shaft and a driven shaft 21 and 22 around which the movement element 20 is fitted. It should be understood that embodiments with one or more drive shafts and one or more driven shafts are anyway comprised in the object of this description. These drive and driven shafts 21, 22 are operatively connected to the movement element 20 for motion transfer. More specifically, the drive and driven shafts 21, 22 are rotated by at least one motor, typically an electric motor, not shown in the attached figures. In the most common cases there is only one motor, which rotates the drive shaft, whereas the driven shaft is an idler shaft, freely rotating. Generally, the drive and driven shafts 21, 22 are equipped with contact and interaction members to contact, and interact with the chain 20, in order to make motion transfer more efficient. In the illustrated embodiments, the contact and interaction members to contact and interact with the movement element 20 comprise at least one smooth or toothed wheel adapted to interact with the plurality of links 201 to transfer the rotary motion of the drive shaft to the chain movement element 20. Typically, when only one drive shaft is provided, the transmission assembly 2 comprises at least one free idler station, such as a smooth or toothed idler wheel assembled to a driven shaft.

For example, as shown in FIGS. 1, 4 and 5, the conveyor equipment 1 preferably comprises at least one conveyor element 3. The conveyor element 3 is connected to the movement element 20 and is configured to transport materials for at least part of the extent of the movement element 20. In a preferred embodiment, such as the one shown in the attached figures, the at least one conveyor element 3 is represented by a container, typically called bucket, adapted to be filled with a given amount of material, for example in the proximity of the drive shaft 21, and to be emptied in the proximity of the other drive shaft 22 located at a height from the ground higher than the first drive shaft 21. In non-illustrated embodiments, said conveyor element 3 may be, for example, a scraper element adapted to drag material for a section of the path along the extent of the movement element 20.

In other embodiments, the movement element 20 of the conveyor equipment 1 may be a belt of the type intended for transporting distinct objects, or it may be an escalator, etc. In practice, according to the invention, such a movement element 20 of the conveyor equipment 1 may be any element that, in the case of path along a closed line, describes a loop path rotating around at least two axes of rotation, that can be defined as a “catenary,” although preferably such a movement element 20 is any mechanical chain of a conveyor equipment for transporting material, regardless of whether such a chain is made of links, plates and pins, or rings, of any metal, plastic, or composite material. As discussed, in other embodiments the conveyor equipment may provide multiple movement elements 20 in parallel, as is the case with conveyors with two or three parallel chains. In addition, the conveyor equipment 1 comprises a wear and/or defectiveness detection system 4. The detection system 4 is operatively connected to the transmission assembly 2 and is configured to detect the state of wear and/or defectiveness of the transmission assembly 2 or at least of part of its components.

It should be noted that although this detection system 4 is described here as being integrated into a chain-type conveyor equipment 1, it is clear to the person skilled in the art that this detection system 4 may apply to any type of conveyor equipment having a transmission assembly with a movement element for material or products which moves along a path that follows an open or closed line, of any type.

In this sense, the wear and/or defectiveness detection system according to an aspect of the invention can be applied as an additional component to pre-existing conveyor equipment, as a retrofitting component.

As illustrated, the detection system 4 comprises at least one first magnetic element 41a and one second magnetic element 41b that are arranged at a distance from each other on the movement element 20. Specifically, in the conveyor equipment 1 shown herein, these first and second magnetic elements are arranged at a distance from each other measured in the feed direction of the movement element 20 in use condition. Therefore, considering the feed direction of the movement element in a use condition, the second magnetic element 41b is arranged upstream of the first magnetic element 41a.

According to an aspect of the invention, the wear and/or defectiveness detection system 4, for example when not directly integrated into a conveyor equipment, may provide for magnetic elements 41a, 41b to be equipped with means, such as mechanical means, for fixing them at a distance from each other on the movement element of the transmission assembly of the conveyor equipment having this detection system 4 operatively combined therewith.

In an embodiment of the invention, in the case where the conveyor equipment is of the chain type with a plurality of links 201, or other movable units, connected to each other with at least one relative degree of freedom, the magnetic elements 41a, 41b may be arranged on only one link 201, that is to say on only one movable unit of the chain.

In general, according to this embodiment implemented on a chain conveyor equipment, the wear and/or defectiveness detection system 4 may comprise at least two magnetic elements 41a, 41b arranged on a single link 201, or plate or ring, or in general movable unit, of the chain. In principle, there can be several links, plates, rings or movable units of the chain conveyor equipment, each of which is equipped with two magnetic elements similar to those denoted herein by the reference numbers 41a, 41b.

In an alternative embodiment, in a chain conveyor equipment at least two magnetic elements 41a, 41b may be respectively arranged on two links, or other movable units, adjacent and connected to each other.

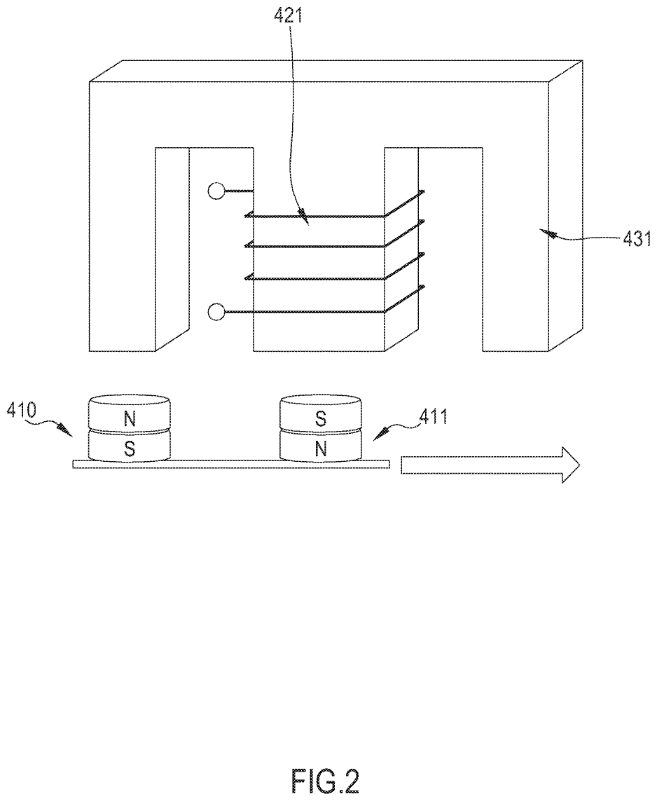

According to a preferred embodiment shown in FIG. 2, each magnetic element 41a, 41b may comprise one or more magnets 410, 411, typically permanent magnets.

Typically, in the case of multiple magnets in a magnetic element 41a, 41b, at least part of the magnets are arranged with poles opposite each other, so that if a first magnet has the positive pole facing the movement element 20, a second magnet has the positive pole facing the movement element 20. The solution shown in the figures, with two magnets having opposite magnetic pole arrangements, turns out to be the preferred embodiment, although in different embodiments different numbers of magnets (possibly even a single magnet) are possible.

The detection system 4 further comprises at least one electrical winding 42a, 42b, 421, each placed (wound) on a respective ferromagnetic core that is arranged fixed, or anyway not integral, with respect to said movement element 20. In other words, each electrical winding 42a, 42b, 421 is fixedly assembled to the conveyor equipment 1, so that the movement of the movement element 20 causes the magnetic elements 41a, 41b, but not the at least one electrical winding 42a, 42b, 421, to be moved.

According to a preferred aspect of the invention, the aforesaid at least two magnetic elements 41a, 41b have opposite polarities facing the at least one electrical winding 42a, 42b.

Preferably, the wear and/or defectiveness detection system 4 may provide means, such as a support frame, for fixedly or anyway not integrally installing the at least one electrical winding 42a, 42b, 421 at the path of the movement element of the transmission assembly of the conveyor equipment with which it is combined, with respect to that movement element and, preferably, at a predetermined distance therefrom. This distance will be chosen as a function of the physical specifications of the at least one magnetic element, the at least one electrical winding, and, as will be seen, as a function of the at least one electric sensor functionally connected to the electrical winding, as well as of the possible dimensional and geometrical constraints of the environment in which the conveyor equipment is located.

As better discussed below, a single electrical winding, or several electrical windings placed at a distance from each other, may be prearranged.

In a known way, the movement of magnetic elements with respect to an electrical winding induces a voltage and an electric current (so-called induced electric current) within the winding. In particular, the at least one electrical winding 42a, 42b, 421 is typically arranged to face the movement element 2, so as to promote the formation of this induced current.

It should be noted that each electrical winding 42a, 42b can consist of a single wire or multiple electrical wires.

The shape of the electrical winding and core can vary between different embodiments.

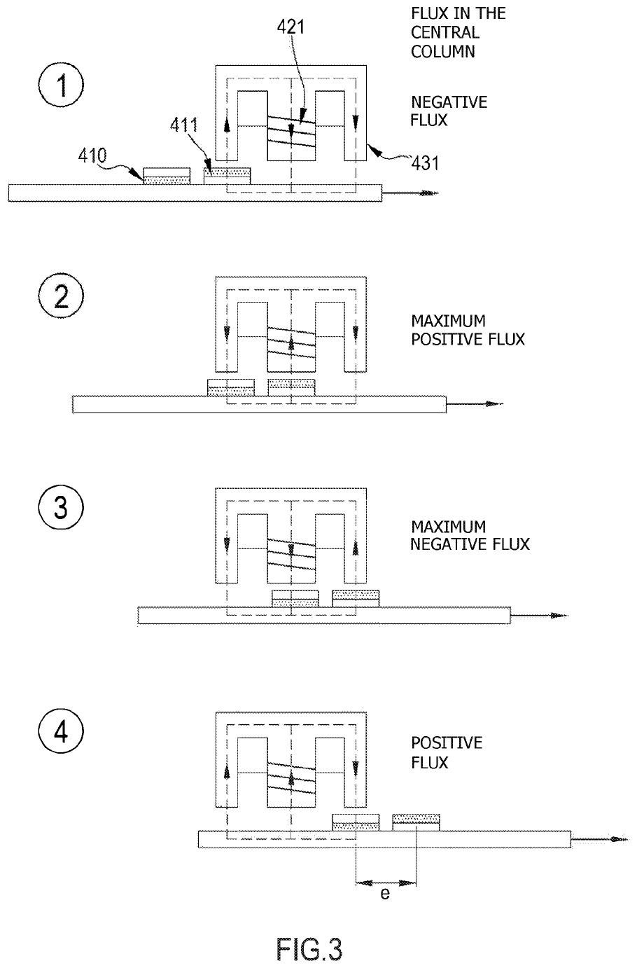

Preferably, as shown in the embodiment of FIGS. 2 and 3, the ferromagnetic core is the central bar of an “E”-shaped ferromagnetic element 431, whose ends of the respective three arms of the “E” face the handling element 2, that is the magnets 410, 411, typically permanent magnets, which form a single magnetic element 41a, 41b. In such a case, the section of the central bar may preferably be larger than the section of the outer bars of the “E”.

In this case, according to this preferred embodiment of the invention, as seen in FIGS. 2 and 3, it is provided that each magnetic element 41a, 41b, arranged on the movement element 20, consists of two permanent magnets 410, 411 which are placed at a distance (e) from each other substantially equal to that between the pairs of the three arms of the “E”-shaped ferromagnetic element 431 of an electrical winding 421, and which are arranged with alternating polarity with respect to each other (i.e. one with the positive pole facing the ferromagnetic element 431, the other with the negative pole facing the latter).

During the motion of the movement element 20, the passage of such magnets 410, 411 constituting a single magnetic element 41, 41b, at the electrical winding 421 arranged on the ferromagnetic element 431, causes several magnetic circuits to be closed, so that the flux in the central bar-having the winding 421 wound thereon-of such ferromagnetic element 431 changes according to the relative position of these magnets 410, 411, so that, as seen in FIG. 3 (which shows a non-limiting example of the arrangement of the magnets 410, 411 and the winding 421 with the corresponding ferromagnetic element 431), as the movement element 20 moves forward with respect to the winding 421, a change of magnetic flux between negative and positive values is determined.

In this embodiment, these magnetic fluxes can be easily detected, as will be seen, by a special electric sensor 45 detecting, for example, a voltage at the ends of the winding 421, and allow the passage of each individual magnetic element 41a, 41b to be accurately determined, each of which consists of two permanent magnets 410, 411, even for high travel speeds of the movement element 20.

More generally, the detection system 4 comprises an electric sensor 45, preferably a voltmeter, to measure an electrical property (i.e. an electrical quantity) of the current induced in the at least one electrical winding 42a, 42b by each magnetic element 41a, 41b, regardless of its configuration (which may, thus, not be the one shown in FIGS. 2 and 3 attached herein). A control unit 44 is connected to the electric sensor 45 (typically by means of a data transmission module 43, either external to the control unit 44 or integrated into it), in order to process the data detected by the electric sensor.

Depending on the embodiment, the data transmission module 43 can be connected to the control unit by cable or wirelessly. For example, at least one of: Bluetooth or similar protocols for WPAN (Standard IEEE 802.15) , Wi-Fi protocols (Standard IEEE 802.11) or RFID protocols can be implemented for the data transmission module 43.

Depending on the embodiment, the control unit 44 can be placed in the proximity of the at least one electric sensor 45 or in a position remote from the at least one electric sensor 45, and more generally from the rest of the conveyor equipment 1. For example, the control unit 44 can be a centralized processing unit shared with other similar conveyor equipment.

As an alternative, the control unit 44 has a distributed architecture and implements a cloud-type service, in which the calculations are deferred to central processing unit, typically a server, which is queried by an application typically residing on an ordinary PC located on the site of the conveyor equipment 1. In more basic embodiments, the control unit 44 is dedicated for each individual conveyor equipment and has installed software that is responsible for evaluating the state of wear and/or defectiveness based on data sent from the at least one electric sensor 45.

In general, the control unit is able to estimate the difference between the actual (i.e. the current) value of the distance between the magnetic elements 41a, 41b and a predefined, i.e. target, value thereof.

In addition, the control unit is able to estimate the speed of motion of the moving elements, and thus of the movement element 20, for the purpose of calculating the distances between the elements as a function of passage times. The speed of motion can otherwise be supplied to the control unit by other external measurement systems already on the machine.

It should be noted that different solutions are possible to arrange electrical windings 42a, 42b in such a way as to achieve what discussed above. Two preferred embodiments are discussed below.

For example, in a possible embodiment a single electrical winding 42a can be arranged. In this case, the electric sensor detects the formation of an induced current caused by the passage of the first magnetic element 41a, and at a later time detects the formation of an induced current caused by the passage of the second magnetic element 41b. Thus, the control unit receives data about the formation of the induced current and is able to calculate the time elapsed between the passage of the first magnetic element 41a and the passage of the second magnetic element at the electrical winding 41a. The feed rate of the movement element 20 can be calculated by the sensor 45 or it can be known to the control unit, such as by other measurement systems. As an alternative, the control unit can have the speed value as data. For speed calculation using the sensor 45, for example, the time taken by a single magnetic element to complete an entire turn of the path of the movement element can be calculated (or in any case two successive passages of a single magnetic element at the movement element, in the case of an open line path). As a matter of fact, the length of the path of the movement element 20 is known, and by calculating the time difference between two passages of a single magnetic element at the electrical winding 42a (and the respective sensor 45), the speed of the movement element 20 can be calculated. Therefore, the control unit can estimate the actual value of the distance between the two magnetic elements 41a, 41b. This actual value can then be compared with the predefined, i.e. target, value, which typically corresponds to the value of the distance at the assembling time of the magnetic elements 41a, 41b.

In a second possible solution, there are two electrical windings 42a, 42b placed at a distance from each other. In particular, they are placed at a distance from each other considering the feed direction of the movement element 20. The distance between the electrical windings 42a, 42b is typically equal to the distance between the magnetic elements 41ad, 41b in the unworn condition of the transmission assembly (i.e. equal to the distance at which the magnetic elements were arranged when the magnetic elements were assembled).

In other words, the electrical windings 42a, 42b are assembled to the conveyor equipment 1 so that if the magnetic elements are at their original distance, the control unit 44 (by means of the electric sensor 44) detects the passage of the first magnetic element 41a at the first electrical winding 42a substantially simultaneously (i.e. simultaneously within a certain tolerance), compared with the passage of the second magnetic element 41b at the second electrical winding 42b. In the same solution, the feed rate of the movement element 20 can be calculated, for example, as a function of the known distances of the electrical windings 42a and 42b, or it can be known to the control unit by other external measurement systems. The speed can be calculated in a manner similar to the embodiment with a sensor (i.e. as a function of the time taken by a single magnetic element to make two successive passages at the same electrical winding) or, more preferably, as a function of the time taken by the same magnetic element to travel the distance between the two electrical windings 42a, 42b. This distance is actually known and does not vary over time.

In general, with an embodiment having two or more electrical windings, the presence of a difference between the actual value and the predefined reference value of the distance can be directly evaluated, particularly by evaluating the time variations of the signals that are detected, without necessarily having to calculate the actual value of the distance between the magnetic elements and/or the speed thereof. However, using the value of the speed (calculated or known to the system), the distance between the magnetic elements can be evaluated or at least the deformation of the magnetic element can be estimated, as a function of the asynchrony of the passage of the magnetic elements at the electrical windings.

In general, the difference between actual and predefined value of the distance between the magnetic elements 41a, 41b can be estimated by detecting the time elapsed between the passage of the magnetic elements at the one or more electrical windings 42a, 42b.

In use, the movement element is moved by integrally dragging the magnetic elements 41a, 41b. When the magnetic elements pass at one of the electrical windings 42a, 42b of the conveyor equipment, the electric sensor detects the formation of an induced voltage and current in the respective electrical winding. The control unit can then estimate, based on the data related to the induced voltage and current and with an appropriate signal processing algorithm, the distance between the windings, or at any rate it can detect the presence of a discrepancy between the predefined reference value (i.e. the target value) of this distance versus the actual value.

In the case of a difference between the actual value and the predefined reference value of the distance between the magnetic elements 41a, 41b, that is to say in the case where this distance is different from (typically higher than) a target value (typically the value of the distance at the assembling time of the magnetic elements 41a, 41b on the movement element 20), the control unit may detect a state of wear of the transmission assembly 2.

If the state of wear is above a predefined threshold, the control unit can, for example, stop the operations of the conveyor equipment and/or signal to an operator that there is an excessive state of wear in the conveyor equipment.

1. A conveyor equipment comprising:
a transmission assembly comprising a movement element movable along a path, optionally in the form of a chain or belt, said transmission assembly further comprising a drive shaft operatively connected to said movement element for motion transfer;
a wear and/or defectiveness detection system operatively connected to said transmission assembly and configured to detect the state of wear and/or defectiveness of said transmission assembly;
wherein said detection system comprises:
a first magnetic element and a second magnetic element arranged at a distance from each other on said movement element,
an electrical winding placed on a respective ferromagnetic core, arranged to be fixed, or anyway not integral, with respect to said movement element,
an electric sensor for the electrical winding, configured to detect one or more electrical properties, optionally at least the voltage of the electric current induced by the relative motion between said electrical winding and said first and second magnetic elements,
a control unit configured to estimate, as a function of the data detected by said electric sensor, the difference between the actual value of the distance between said first magnetic element and said second magnetic element and a predefined reference value of the distance between said first magnetic element and said second magnetic element, to detect a state of wear and/or defectiveness of said transmission assembly.

2. The conveyor equipment according to claim 1, further comprising a conveyor element connected to said movement element and configured to transport materials.

3. The conveyor equipment according to claim 1, wherein at least one of said first and said second magnetic elements comprises a permanent magnet.

4. The conveyor equipment according to claim 1, wherein said ferromagnetic core is the central bar of an “E-shaped” ferromagnetic element.

5. The conveyor equipment according to claim 1, wherein said first and said second magnetic elements have opposite polarities facing said electrical winding.

6. The conveyor equipment according to claim 1, wherein said conveyor equipment is of the chain type with movable units chained together with at least one degree of freedom, wherein said first and said second magnetic elements are arranged on a single movable unit.

7. The conveyor equipment according to claim 1, configured so that the control unit evaluates the difference between actual value and predefined reference value of the distance between the magnetic elements as a function of the time difference elapsed between the passage of the magnetic elements at the same electrical winding.

8. The conveyor equipment according to claim 1, configured so that the control unit evaluates the difference between actual value and predefined reference value of the distance between the magnetic elements as a function of the time difference elapsed between the passage of the magnetic elements at different electrical windings placed at a predetermined distance from each other.

9. A detection system to detect the wear and/or defectiveness of a movement element, movable along a path, of a transmission assembly of a conveyor equipment, said detection system being configured to be operatively connected to the transmission assembly and to detect the state of wear and/or defectiveness of said transmission assembly comprising:
a first magnetic element and a second magnetic element both shaped to be fixed on said movement element,
an electrical winding placed on a relative ferromagnetic core,
an electric sensor for the electrical winding configured to detect one or more electrical properties optionally at least the voltage of the electric current induced by the relative motion between said electrical winding and said first and second magnetic elements,
a control unit, configured to estimate, as a function of the data detected by said electric sensor, the difference between the actual value of the distance between said first magnetic element and said second magnetic element and a predefined reference value of the distance between said first magnetic element and said second magnetic element, to detect a state of wear and/or defectiveness of said transmission assembly.

10. The detection system according to claim 2, wherein at least one of said first and said second magnetic elements comprises a permanent magnet.

11. The detection system according to claim 9, wherein said ferromagnetic core is the central bar of an “E-shaped” ferromagnetic element.

12. A method of detecting the state of wear and/or defectiveness of a conveyor equipment according to claim 1, comprising:
actuating said transmission assembly, so as to move said movement element and the magnetic elements integral therewith;
estimating, by said sensor, the difference between the actual value of the distance between said first magnetic element and said second magnetic element and a predefined reference value of the distance between said first magnetic element and said second magnetic element, to detect a state of wear and/or defectiveness of said transmission assembly;
evaluating a state of wear and/or defectiveness of the transmission assembly as a function of the estimation of said distance.

13. The method according to claim 12, wherein the control unit evaluates the difference between actual value and predefined reference value of the distance between the magnetic elements as a function of the time difference elapsed between the passage of the magnetic elements at the same electrical winding.

14. The method according to claim 12, wherein the control unit evaluates the difference between actual value and predefined reference value of the distance between the magnetic elements as a function of the time difference elapsed between the passage of the magnetic elements at two or more different electrical windings placed at a distance from each other.

15. The conveyor equipment according to claim 3, wherein both said first and said second magnetic elements comprises permanent magnets.

16. The conveyor equipment according to claim 6, wherein said conveyor equipment is of the chain type with movable links, plates or rings.

17. The detection system equipment according to claim 10, wherein both said first and said second magnetic elements comprises permanent magnets.
